(19) United States
(12) Patent Application Publication
(10) Pub. No.: US 2026/0230015 A1
(43) Pub. Date: Aug. 6, 2026

(54) SYSTEM AND METHOD FOR COMPENSATING FOR ELECTROMECHANICAL OSCILLATION ANGLE IN A MOTOR DRIVE

(71) Applicant: Nidec Motor Corporation, St. Louis, MO (US)

(72) Inventors: Athanasios Sarigiannidis, Markopoulo (GR); Nikolaos Tsakalakis, Markopoulo (GR); Nikolaos Kampouroglou, Markopoulo (GR); Nektarios Karakasis, Markopoulo (GR)

(73) Assignee: Nidec Motor Corporation, St. Louis, MO (US)

(21) Appl. No.: 19/192,563

(22) Filed: Apr. 29, 2025

(30) Foreign Application Priority Data
Feb. 6, 2025 (GR) 20250100097

(51) Int. Cl. H02P 6/20

(52) U.S. Cl. CPC H02P 6/20

(57) ABSTRACT

A system and method for compensating for an electromechanical angle oscillation that occurs during a start-up of a sensorless permanent magnet motor drive. An actual motor output power of a permanent magnet motor is measured, and an ideal motor output power of the motor is determined. The ideal output power may be based on a mechanical speed, a current command, and a torque constant. The actual output power may be based on a converter loss, a copper loss, and a direct current input power. An oscillation compensation angle is determined based on the measured actual output power and the determined ideal output power. The determined oscillation compensation angle is added to a reference angle to produce a final angle, and the final angle is used to control operation of the permanent magnet motor drive as it supplies power to the motor, including compensating for the electromechanical angle oscillation.

### RELATED APPLICATION

The present U.S. non-provisional patent application is related to and claims priority benefit of an earlier-filed Greek patent application titled “System and Method for Compensating for Electromechanical Oscillation Angle in a Motor Drive,” Ser. No. 20250100097, filed Feb. 6, 2025. The entire content of the identified earlier-filed patent application is incorporated by reference as if fully set forth herein.

### FIELD

The present disclosure relates to systems and methods for controlling operations of electric motors, and more particularly, embodiments concern a system and method for compensating for an electromechanical oscillation angle in a permanent magnet motor drive.

### BACKGROUND

It is generally desirable to improve the performance of electric motors, but it can be difficult and/or costly to do so. For example, sensorless permanent magnet motor (PMM) drives are valued for their efficiency, compact design, and robust performance across a wide range of applications. The sensorless mode of operation eliminates the need for a physical sensor to determine rotor position, which reduces cost and complexity while enhancing reliability. However, it can be challenging to accurately estimate rotor position for optimal motor control. One challenge arises from the inherent limitations of sensorless control techniques at low or zero speeds as conventional methods struggle to reliably determine the rotor position. This uncertainty can lead to suboptimal performance, instability, and even electromechanical oscillations that are created by the system's mechanical inertia and can adversely affect the dynamic and steady-state operation of the motor. Electromechanical oscillations are particularly problematic as they can degrade motor performance, increase power losses, and reduce overall system reliability. These oscillations are exacerbated by the inability of conventional sensorless techniques to accurately compensate for rotor angle deviations during operation, especially under varying load and speed conditions.

This background discussion is intended to provide related information, and is not necessarily prior art.

### SUMMARY

Embodiments provide a system and method for more efficient compensation of electromechanical angle oscillations that occur during a start-up process of a PMM drive. Broadly, an initial analysis of the cause of electromechanical vibrations provoked during an open-loop sensorless start-up process may be performed. A subsequent real-time vibration compensation strategy may be implemented based on a measured motor output power and an ideal motor output power, in which a determined oscillation compensation angle may be added to a reference electric angle to produce a final angle that may be used by a motor controller to control operation of the PMM drive, including compensating for the electromechanical angle oscillation.

Embodiments provide improvements over conventional open-loop start-up methods. While conventional methods focus only on controlling a main sensorless angle after start-up, embodiments of the present invention effectively compensate for electromechanical angle oscillations provoked during start-up. Embodiments advantageously mitigate the effects of rotor position estimation inaccuracies by introducing a robust compensation mechanism that suppresses oscillations and enhances system stability. Embodiments advantageously provide a smoother and more reliable starting process, resulting in fewer start-up failures, less speed fluctuation, and less ripple during steady state operation.

In an embodiment, a system may include a sensorless PMM drive configured to control a power supplied to a PMM, and a motor controller configured to perform at least the following functions. The motor controller may measure an actual motor output power of the PMM, determine an ideal motor output power of the PMM, determine an oscillation compensation angle based on the actual motor output power and the ideal motor output power, add the oscillation compensation angle to a reference angle to produce a final angle, and control operation of the sensorless PMM drive, including compensate for the electromechanical angle oscillation, using the final angle.

In various implementations, the preceding embodiment may further include any one or more of the following features. The ideal motor output power of the PMM may be determined based on a mechanical speed, a current command, and a torque constant of the PMM. The actual motor output power of the PMM may be measured based on a converter loss, a copper loss, and a direct current (DC) input power of the PMM.

In another embodiment, a system for compensating for an electromechanical angle oscillation that occurs during a start-up of a sensorless PMM drive may include a PMM, the sensorless PMM drive, and a motor controller. The PMM may include a stator, a rotor, and shaft. The sensorless PMM drive may control a power supplied to the PMM. The motor controller may be configured to perform at least the following functions to compensate for the electromechanical angle oscillation. The motor controller may measure an actual motor output power of the PMM, determine an ideal motor output power of the PMM, determine an oscillation compensation angle based on the actual motor output power and the ideal motor output power, add the oscillation compensation angle to a reference angle to produce a final angle, and control operation of the PMM drive using the final angle.

In various implementations, the preceding embodiment may further include any one or more of the following features. The ideal motor output power of the PMM may be determined based on a mechanical speed, a current command, and a torque constant of the PMM. The actual motor output power of the PMM may be measured based on a converter loss, a copper loss, and a DC input power of the PMM. The system may further include a propeller coupled with the shaft.

In another embodiment, a method for compensating for an electromechanical angle oscillation that occurs during a start-up of a sensorless PMM drive that controls a power supplied to a PMM may include the following operations. An actual motor output power of a PMM may be measured, and an ideal motor output power of the PMM may be determined. An oscillation compensation angle may be determined based on the actual motor output power and the ideal motor output power. The oscillation compensation angle may be added to a reference angle to produce a final electric angle. The operation of the sensorless PMM drive may be controlled, including compensating for the electromechanical angle oscillation, using the final angle.

In various implementations, the preceding embodiment may further include any one or more of the following features. The ideal motor output power of the PMM may be measured based on a mechanical speed, a current command, and a torque constant of the PMM. The actual motor output power of the PMM may be measured based on a converter loss, a copper loss, and a DC input power of the PMM.

This summary is not intended to identify essential features of the embodiments, and is not intended to be used to limit the scope of the claims. These and other aspects of the present invention are described below in greater detail.

### DRAWINGS

Embodiments are described in detail below with reference to the attached drawing figures, wherein:

FIG. 1 is a high-level block diagram of a system for compensating for an electromechanical angle oscillation that occurs during a start-up of a sensorless PMM drive;

FIG. 2 is a flowchart of operations in an embodiment of a method for compensating for an electromechanical angle oscillation that occurs during a start-up of a sensorless PMM drive;

FIG. 3 is a block diagram of operations in an embodiment of a method for analyzing open-loop vibration components in a sensorless PMM drive;

FIG. 4 is a block diagram of operations in an embodiment of a method for compensating for an electromechanical angle oscillation that occurs during a start-up of a sensorless PMM drive;

FIG. 5A is a graph of motor speed versus time showing the open-loop start-up performance of a conventional system given a one hundred fifty (150) revolutions per minute (RPM) reference speed command;

FIG. 5B is a graph of motor speed versus time showing the open-loop start-up performance of an embodiment of the present invention given a one hundred fifty (150) RPM reference speed command;

FIG. 6A is a graph of motor speed versus time showing the open-loop start-up performance of a conventional system given a two hundred twenty (220) RPM reference speed command;

FIG. 6B is a graph of motor speed versus time showing the open-loop start-up performance of an embodiment of the present invention given a two hundred twenty (220) RPM reference speed command;

FIG. 7A is a graph of motor speed versus time showing the open-loop start-up performance of a conventional system given a four hundred (400) RPM reference speed command from standstill, with a one thousand five hundred (1500) RPM per second acceleration; and

FIG. 7B is a graph of motor speed versus time showing the open-loop start-up performance of an embodiment of the present invention given a four hundred (400) RPM reference speed command from standstill, with a one thousand five hundred (1500) RPM per second acceleration.

The figures are not intended to limit the embodiments to the specific details depict. The drawings are not necessarily drawn to scale.

### DETAILED DESCRIPTION

In the following detailed description, reference is made to the accompanying drawings, which form a part hereof and in which are shown, by way of illustration, specific embodiments in which the present disclosure may be practiced. These embodiments are described in sufficient detail to enable a person of ordinary skill in the art to practice the present disclosure. However, other embodiments may be utilized, and structural, material, procedural, operational, and other changes may be made without departing from the scope of the disclosure. Unless clearly understood or expressly identified otherwise, structures, materials, procedures, operations, and other aspects described in the context of one embodiment may be incorporated into other embodiments. The illustrations presented herein are not meant to be actual views of any particular method, system, device, or structure, but are merely idealized representations that are employed to describe the embodiments of the present disclosure. Similar structures or components in the various drawings may retain the same or similar numbering for the convenience of the reader; however, any similarity in numbering does not necessarily mean that the structures or components are necessarily identical in size, composition, configuration, or any other property. Terms of relative location and direction (for example, above, below, left, right, upper, lower) may be used to facilitate the present descriptions of embodiments with reference to the figures, but unless clearly understood or expressly identified otherwise, these terms are not meant to be limiting with regard to location, direction, or overall orientation, and may, for example, change as a result of a change in overall orientation. It will be readily understood that the components of the embodiments as generally described herein and illustrated in the drawings could be arranged and designed in a wide variety of different configurations. Thus, the following description is not intended to limit the scope of the present disclosure but is merely representative of various embodiments.

It will be appreciated that many electric motor applications, such as marine and semi-servo systems, may require relatively aggressive acceleration profiles, for which conventional startup sensorless algorithms may be impractical. In particular, in complex scenarios requiring aggressive accelerations and variable loading, the supplied sensorless electric angle in the open-loop stage attempts to self-stabilize with the actual rotor angle. This self-stabilization action can lead to electromechanical torque angle oscillations, which can result in failed startups and speed overshoots.

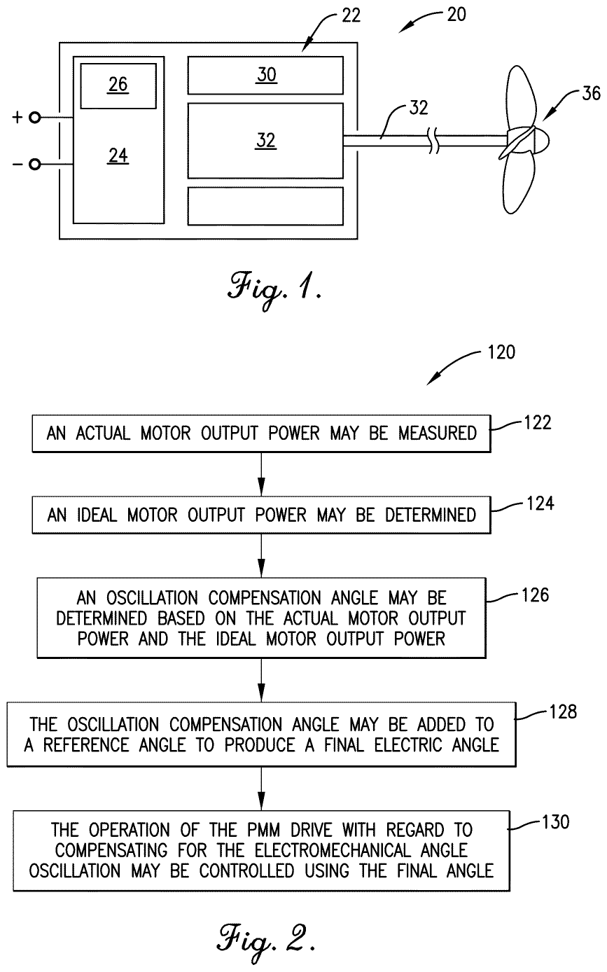

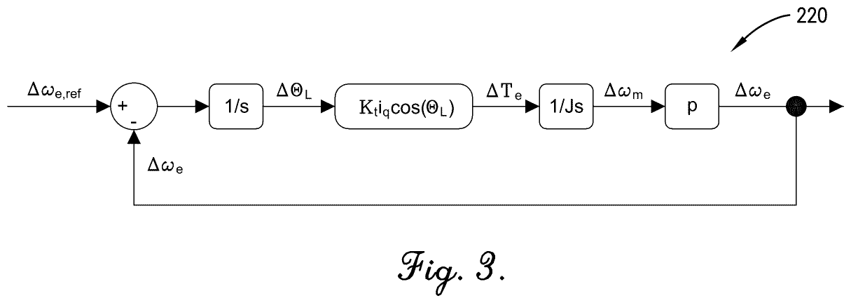

Embodiments provide a system, as shown in FIG. 1, and method, as shown in FIG. 2, for more efficient compensation of electromechanical angle oscillations that occur during a start-up process of a PMM drive. Broadly, an initial analysis of the cause of electromechanical vibrations provoked during an open-loop sensorless start-up process may be performed, as shown in FIG. 3. Then, a real-time vibration compensation strategy may be implemented based on a measured motor output power and an ideal motor output power, in which a calculated oscillation compensation angle is added to a reference electric angle to produce a final angle that is used by a motor controller to control operation of the PMM drive, including compensating for the electromechanical angle oscillation, as shown in FIG. 4. After start-up and once the motor speed exceeds a predefined threshold, the main sensorless observer (for example, a flux observer) may take over responsible for the angle estimation.

Embodiments provide improvements over conventional open-loop start-up methods that derive the electric angle directly from the reference speed. For example, conventional methods focus only on controlling a main sensorless angle after start-up, while embodiments of the present invention effectively compensate for electromechanical angle oscillations provoked during start-up. Embodiments advantageously mitigate the effects of rotor position estimation inaccuracies by introducing a robust compensation mechanism that suppresses oscillations and enhances system stability. Further, embodiments advantageously provide a smoother and more reliable starting process from standstill to transition from open-loop to closed-loop sensorless control, resulting in fewer start-up failures, less speed fluctuation, and less ripple (in one example, up to eighty percent (80%) less ripple) during steady state operation. Applications for the present technology include, for example, variable speed propulsion watercraft. In such applications, it is desirable to have a dependable sensorless start-up method at low speeds that is capable of managing high torque demands (for example, when a propeller becomes entangled in weeds) and that supports high acceleration rates up to the rated speed, ensuring a seamless transition from open-loop start-up to closed-loop field-oriented control (FOC) sensorless techniques.

Referring to FIG. 1, an embodiment of a system 20 is shown for compensating for an electromechanical angle oscillation that occurs during a start-up of a PMM drive. Broadly, the system 20 may include a PMM 22, a sensorless PMM drive 24, and a motor controller 26. The PMM 22 may be substantially any suitable PMM, such as those made by Nidec Motor Corporation, and may include a stator 30, a rotor 32, and a shaft 34 for driving a load 36. The load could be, for example, a propeller. The sensorless PMM drive 24 may be configured to control the electrical power supplied to the PMM 22 in order to control the speed, torque, and direction of the PMM 22.

The motor controller 26 may be configured to compensate for this electromechanical angle oscillation. Broadly, this may be accomplished as follows, with additional details being provided below. The motor controller 26 may measure an actual motor output power of the PMM 22; determine an ideal motor output power of the PMM 22; determine an oscillation compensation angle based on the actual motor output power and the ideal motor output power; add the oscillation compensation angle to a reference angle to produce a final angle; and control operation of the sensorless PMM drive 24, including compensating for the electromechanical angle oscillation, using the final angle. The ideal motor output power of the PMM 22 may be measured based on a mechanical speed, a current command, and a torque constant. The actual motor output power of the PMM 22 may be determined based on a converter loss, a copper loss, and a DC input power.

Referring to FIG. 2, an embodiment of a method 120 is shown for compensating for an electromechanical angle oscillation that occurs during a start-up of a PMM drive. In practice, the method 120 may be implemented by a motor controller. Broadly, the method 120 may include the following steps. An actual motor output power of a PMM may be measured, as shown in 122 and seen in FIG. 4. An ideal motor output power of the PMM may be determined, as shown in 124 and seen in FIG. 4. An oscillation compensation angle may be determined based on the actual motor output power and the ideal motor output power, as shown in 126 and seen in FIG. 4. The oscillation compensation angle may be added to a reference angle to produce a final electric angle, as shown in 128 and seen in FIG. 4. The operation of a PMM drive that supplies power to the PMM may be controlled using the final angle with regard to compensating for the electromechanical angle oscillation, as shown in 130.

In more detail, vibrations generally occur during open-loop control when the estimation of the rotor position is less accurate and the loading from the mechanical system is typically non-linear with higher demands when starting from a standstill. If the control system attempts to transition to sensorless control under vibrations, then there is a high possibility of failure due to an overcurrent or stall event, which depends on the angle discrepancy.

The relationship between the current iq in the synchronous dq frame and the produced electromagnetic torque Te may be defined by Equation 1:

$$\begin{matrix}{T}_{e} = \frac{3}{2} {pi}_{q} cos {θ}_{L} ( {Ψ}_{PM} + ( {L}_{{d}^{-}} {L}_{q} ) {i}_{q} sin {θ}_{L} ) \\ \approx {K}_{t} {i}_{q} cos {θ}_{L}\end{matrix}$$

wherein, p represents the number of pole pairs of the machine, Kₜ is the motor torque constant, Ψ_{PM} is the permanent magnet flux, θ_{L} is the angular difference between the synchronous rotating d-q reference frame and the actual rotor d′-q′ reference frame, and L_{d} and L_{q} are the stator d and q axis inductances, respectively. Typically, in a surface-mounted PMM, L_{d} is approximately equal to L_{q}, so the reluctance torque term is almost zero. From Equation 1, it will be appreciated that a fluctuation component of the angle θ_{L} could provoke a fluctuation of the produced torque and increase the vibration of the motor drive.

Referring to FIG. 3, a control block diagram 220 is shown for performing an initial analysis of the cause of electromechanical vibrations provoked during an open-loop sensorless start-up process, wherein, Δω_{e,ref} expresses the vibration of speed command and is one input to the analysis; Δωₑ is the vibration of electrical speed and the output of the analysis as well as another input to the analysis via feedback from the output; Δωₘ is the vibration of mechanical speed; ΔTₑ is the torque fluctuation; and AOL is the vibration of angular error. When integrating the speed vibration components, a fluctuation component of the angular error Δθ_{L} is generated. Subsequently, a torque fluctuation component is produced based on Equation 1, which generates mechanical speed vibrations, affected by the mechanical system inertia. Based on Equation 1, the correlation between the measured active power and the optimal reference active power may be expressed by Equation 2:

$${P}_{m} = {P}_{m}^{*} cos {θ}_{L}$$

wherein, Pₘ is the calculated motor output power.

$${P}_{m}^{*}$$

is the reference output power applied to the motor and may be calculated from Equations 3 and 4:

$${P}_{m} = {T}_{e} {ω}_{m}$$

$${P}_{m}^{*} = {K}_{t} {i}_{q} {ω}_{m}$$

wherein, ωₘ is the mechanical angular speed.

For the calculation of measured motor output power it is desirable to know the input DC power as well as the motor drive losses, which are primarily converter losses and copper losses. Therefore, from Equation 2, angle θ_{L}, which describes the angular difference between the synchronous rotating d-q reference frame and the actual rotor d′-q′ reference frame, can be estimated from motor output power measured and reference (optimal) values. The variation of this angle is directly related to the mechanical system vibration during the start-up process.

Referring to FIG. 4, a control block diagram 320 is shown for performing real-time vibration compensation based on the measured motor output power and the ideal motor output power, in which a calculated oscillation compensation angle is added to a reference electric angle to produce a final angle that is used by a motor controller to control operation of the PMM drive, including compensating for the electromechanical angle oscillation. A motor output power reference may be determined based on inputs ω_{m,ref}, I_{q,ref}, which is a current command, and Kₜ. An estimated actual output motor power may be determined based on inputs from a converter loss estimator 322, from a copper loss estimator 324, and P_{dc}, which is DC input power. The output of the method is ϑ_{OL}, which is the final angle output by the motor controller to control operation of the PMM drive with regard to compensating for the electromechanical angle oscillation.

In more detail, embodiments use the correlation of the fluctuation of the angle θ_{L} with the mechanical speed oscillations, utilizing the calculated motor output power from measured voltage and current values. Two filters are introduced in the method, one low pass filter (LPF) 326, to smoothen the angle waveform added into the electric angle, and one high pass filter (HPF) 328, to remove the DC offset and apply only the alternating current (AC) component of the angle θ_{L} related to the electromechanical vibrations. The low pass filter bandwidth is proportional to the commanded speed, while for the high pass filter a bandwidth of one-point-six (1.6) Hertz (Hz) is used to remove the DC offset. Finally, the resulting compensating θ_{e,comp} angle is added to the referenced angle θ_{e,ref}, the appropriate modulo operation is applied in order to sustain the angle value between zero (0) and two pi (2π), and the final angle is provided to the PMM drive for use in controlling operation of the PMM.

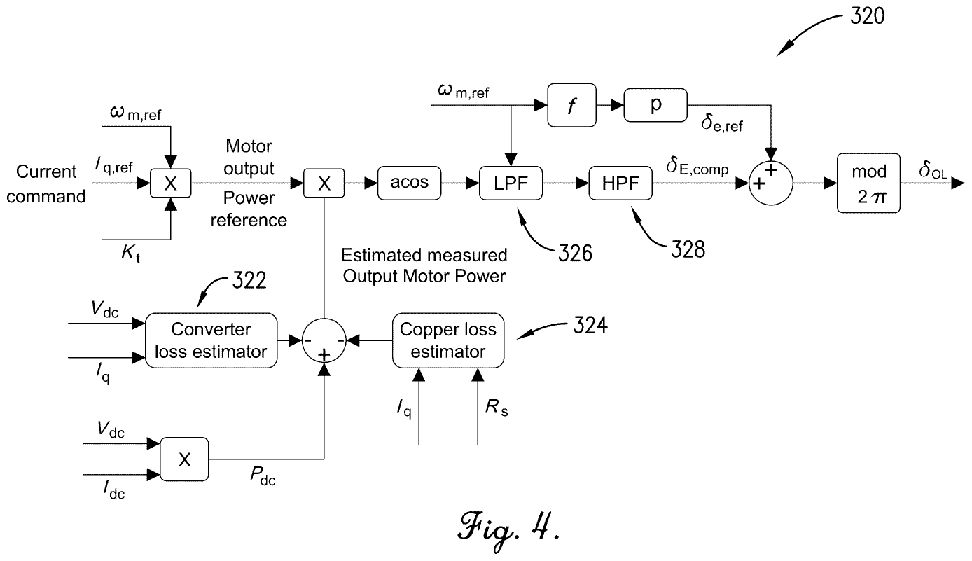

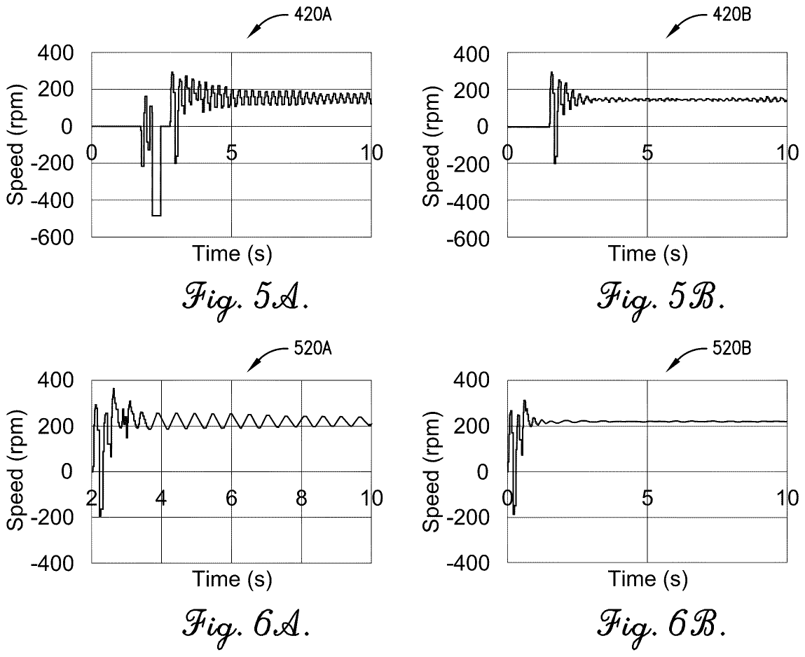

Referring to FIGS. 5A-7B, experimental results are shown comparing the open-loop startup performance of a conventional system to the open-loop startup performance of a system incorporating an embodiment of the present invention. In particular, FIG. 5A shows the performance 420A of a conventional system given a one hundred fifty (150) RPM reference speed command, and FIG. 5B shows the performance 420B of a system incorporating an embodiment of the present invention given the same reference speed command. Speed oscillations are reduced from +/−thirty-eight (38) RPM for the former to +/−five (5) RPM for the latter in steady-state operation.

Similarly, FIG. 6A shows the performance 520A of the conventional system given a two hundred (200) RPM reference speed command, and FIG. 6B shows the performance 520B of the system incorporating an embodiment of the present invention given the same reference speed command. In this case, speed oscillations are reduced from +/−fifteen (15) RPM for the former to +/−two (2) RPM for the latter in steady-state operation.

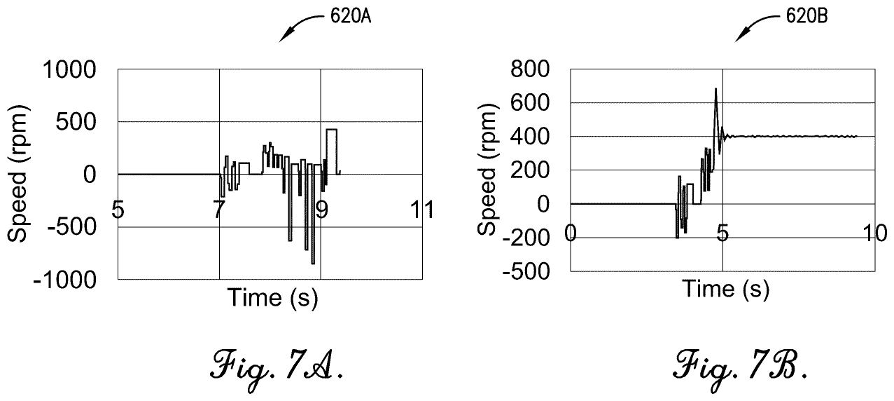

FIG. 7A shows the performance 620A of the conventional system given a four hundred (400) rpm reference speed command from standstill, with a one thousand five hundred (1500) rpm/second acceleration, and FIG. 7B shows the performance 620B of the system incorporating an embodiment of the present invention under the same circumstances. In this case, the conventional system failed to start, while the system incorporating an embodiment of the present invention successfully started while experiencing a small transient overshoot.

While the present disclosure has been described herein with respect to certain illustrated embodiments, those of ordinary skill in the art will recognize and appreciate that the present disclosure is not so limited. Rather, many additions, deletions, and modifications to the illustrated and described embodiments may be made without departing from the scope of the disclosure as hereinafter claimed along with their legal equivalents. In addition, features from one embodiment may be combined with features of another embodiment while still being encompassed within the scope of the disclosure as contemplated by the inventors.

1. A system comprising:
a sensorless permanent magnetic motor drive configured to control a power supplied to a permanent magnet motor;
a motor controller configured to perform at least the following functions—
measure an actual motor output power of the permanent magnetic motor;
determine an ideal motor output power of the permanent magnet motor;
determine an oscillation compensation angle based on the actual motor output power and the ideal motor output power;
add the oscillation compensation angle to a reference angle to produce a final angle; and
control operation of the sensorless permanent magnet motor drive, including compensate for an electromechanical angle oscillation, using the final angle.

2. The system of claim 1, wherein ideal motor output power of the permanent magnetic motor is determined based on a mechanical speed, a current command, and a torque constant of the permanent magnet motor.

3. The system of claim 2, wherein the actual motor output power of the permanent magnet motor is measured based on a converter loss, a copper loss, and a direct current input power of the permanent magnet motor.

4. The system of claim 1, wherein the actual motor output power of the permanent magnet motor is determined based on a converter loss, a copper loss, and a direct current input power of the permanent magnet motor.

5. A system for compensating for an electromechanical angle oscillation that occurs during a start-up of a sensorless permanent magnet motor drive, the system comprising:
a permanent magnet motor including a stator, a rotor, and shaft;
a sensorless permanent magnet motor drive configured to control a power supplied to the permanent magnet motor; and
a motor controller configured to perform at least the following functions to compensate for the electromechanical angle oscillation—
measure an actual motor output power of the permanent magnet motor;
determine an ideal motor output power of the permanent magnet motor;
determine an oscillation compensation angle based on the actual motor output power and the ideal motor output power;
add the oscillation compensation angle to a reference angle to produce a final angle; and
control operation of the sensorless permanent magnet motor drive using the final angle.

6. The system of claim 5, wherein ideal motor output power of the permanent magnetic motor is measured based on a mechanical speed, a current command, and a torque constant of the permanent magnet motor.

7. The system of claim 6, wherein the actual motor output power of the permanent magnet motor is determined based on a converter loss, a copper loss, and a direct current input power of the permanent magnet motor.

8. The system of claim 5, wherein the actual motor output power of the permanent magnet motor is determined based on a converter loss, a copper loss, and a direct current input power of the permanent magnet motor.

9. The system of claim 5, further including a propeller coupled with the shaft.

10. A method for compensating for an electromechanical angle oscillation that occurs during a start-up of a sensorless permanent magnet motor drive that controls a power supplied to a permanent magnet motor, the method comprising:
measuring an actual motor output power the permanent magnet motor;
determining an ideal motor output power of the permanent magnet motor;
determining an oscillation compensation angle based on the actual motor output power and the ideal motor output power;
adding the oscillation compensation angle to a reference angle to produce a final electric angle; and
controlling operation of the sensorless permanent magnet motor drive, including compensating for the electromechanical angle oscillation, using the final angle.

11. The method of claim 10, wherein ideal motor output power of the permanent magnetic motor is measured based on a mechanical speed, a current command, and a torque constant of the permanent magnet motor.

12. The method of claim 11, wherein the actual motor output power of the permanent magnet motor is determined based on a converter loss, a copper loss, and a direct current input power of the permanent magnet motor.

13. The method of claim 10, wherein the actual motor output power of the permanent magnet motor is determined based on a converter loss, a copper loss, and a direct current input power of the permanent magnet motor.
